(19) United States
(12) Patent Application Publication
(10) Pub. No.: US 2008/0252019 A1
(43) Pub. Date: Oct. 16, 2008

(54) OIL SEALING RING

(76) Inventor: Xiuming YU, Handan (CN)

Correspondence Address: MATTHIAS SCHOLL, 14781 MEMORIAL DRIVE, SUITE 1319, HOUSTON, TX, 77079, US

(21) Appl. No.: 12/145,786

(22) Filed: Jun. 25, 2008

Related U.S. Application Data
(63) Continuation-in-part of application No. PCT/CN2006/003551, filed on Dec. 22, 2006.

(30) Foreign Application Priority Data
Dec. 25, 2005 (CN) 200510097149.7
Oct. 6, 2007 (CN) 200710181090.9
Oct. 13, 2007 (CN) 200710182249.9
Dec. 23, 2007 (CN) 200710305525.6
Dec. 28, 2007 (CN) 200710300863.0
Dec. 28, 2007 (CN) 200710308027.7

(51) Int. Cl. F16J 9/12

(52) U.S. Cl. 277/434

(57) ABSTRACT

An oil ring, particularly disposed in an oil ring outer-groove of a piston in an internal combustion engine or an air compressor, comprising a base ring (2) having a split, and an annular flange (1) radially-protruding outwards and disposed on outer circumferential surface of the base ring (2).

### CROSS-REFERENCE TO RELATED APPLICATIONS

This application is a continuation-in-part of International Patent Application No. PCT/CN2006/003551, with an international filing date of Dec. 22, 2006, designating the United States, now pending, which is based on Chinese Patent Application Number 200510097149.7 filed Dec. 25, 2005, and further claims priority benefits to Chinese Patent Application Numbers 200710181090.9 filed Oct. 6, 2007, 200710182249.9 filed Oct. 13, 2007, 200710305525.6 filed Dec. 23, 2007, 200710300863.0 filed on Dec. 28, 2007, and 200710308027.7 file on Dec. 28, 2007. The contents of all of the aforementioned specifications are incorporated herein by reference.

### BACKGROUND OF THE INVENTION

1. Field of the Invention

The invention relates to an oil ring, and particularly to an oil ring disposed in an oil ring outer-groove of a piston in an internal combustion engine or an air compressor.

2. Description of the Related Art

Conventionally, an oil ring used in a piston-type diesel engine piston ring is divided into two types: a base ring having a split, an annular flange (oil scraping side) radially-protruding outwards is disposed at the top of outer circumferential surface of the base ring, and an outer-groove for receiving a coil loaded spring is axially disposed at the center of the inner circumferential surface of the base ring. A base ring having a split, an annular upper flange (upper oil scraping side) radially-protruding outwards is disposed at the top of the outer circumferential surface of the base ring. An annular lower flange (lower oil scraping side) radially-protruding outwards is disposed at the bottom of the outer circumferential surface of the base ring. An oil-leakage channel is radially-disposed on the base ring. An outer-groove for receiving a coil loaded spring is axially disposed at the center of inner circumferential surface of the base ring.

However, a problem with above-mentioned oil rings is that oil leakage often occurs at the split of the base ring.

### SUMMARY OF THE INVENTION

An objective of the invention is to provide a sealed oil ring that prevents oil leakage in a split of a base ring, and improves sealing performance of the oil ring.

The objective of the invention is implemented as follows.

In one embodiment of the present invention provided is an oil sealing ring, comprising a base ring having a split; and an annular flange radially-protruding outwards and disposed on outer circumferential surface of the base ring, wherein an axially-traversed trough is disposed on inner circumferential surface to the left of the split of the base ring, a radially-traversed upper groove is disposed on upper surface (including part of the flange) to the left of the split of the base ring, an outer radial lapping/overlapping segment and an outer axial-radial lapping/overlapping segment are formed to the left of the base ring, an axially-traversed outer-groove is disposed on outer circumferential surface to the right of the base ring, a groove is disposed on outer circumferential surface to the right (including part of the flange and parts therebelow) of the axially-traversed outer-groove, the outer axial-radial lapping segment to the left of the base ring is inserted into the groove to the right of the base ring, and the outer radial lapping segment to the left of the base ring is inserted into the axially-traversed outer-groove to the right of the base ring.

In another embodiment of the present invention provided is an oil sealing ring, comprising a base ring having a split, and an annular flange radially-protruding outwards and disposed on outer circumferential surface of the base ring, wherein an axially-traversed trough is disposed on inner circumferential surface to the left of the split of the base ring, a radially-traversed upper groove is disposed on upper surface (including part of the flange) to the left of the split of the base ring, an outer axial-radial lapping segment is formed to the left of the base ring, a groove is disposed on outer circumferential surface to the right (including part of the flange and parts therebelow) of the split of the base ring, and the outer axial-radial lapping segment to the left of the base ring is inserted into the groove to the right of the base ring.

In another embodiment of the present invention provided is an oil sealing ring, comprising a base ring having a split, and an annular flange radially-protruding outwards and disposed on outer circumferential surface of the base ring, wherein an axially-traversed trough is disposed on inner circumferential surface to the left of the split of the base ring, a radially-traversed lower groove is disposed to the left of the split of the base ring, an outer axial and radial lapping segment is formed to the left of the base ring, an upper groove is disposed at the top (including part of the flange) of outer circumferential surface to the right of the split of the base ring, and the lapping segment to the left of the base ring is inserted into the upper groove to the right of the base ring.

Preferably, a spring expanding ring is disposed on inner circumferential surface of the base ring.

In another embodiment of the present invention provided is an oil sealing ring, comprising a base ring having a split, and an annular flange radially-protruding outwards and disposed on outer circumferential surface of the base ring, wherein a radially-traversed upper trough is disposed on upper surface of both ends of the split of the base ring, an axially-traversed groove is disposed on inner circumferential surface of both ends of the split of the base ring, an arc-shaped sealing segment is disposed in the axially-traversed groove, an arc-shaped upper-scraping-ring is disposed in the radially-traversed upper trough, and a spring expanding ring is disposed on inner circumferential surface of the base ring and the arc-shaped sealing segment.

Preferably, only one annular upper-flange radially-protruding outwards is disposed on outer circumferential surface of the base ring, and the annular upper-flange is disposed at the top of the outer circumferential surface of the base ring.

Preferably, only one annular middle-flange radially-protruding outwards is disposed on outer circumferential surface of the base ring, and the annular middle-flange is disposed in the middle of the outer circumferential surface of the base ring.

Preferably, only one annular upper-flange radially-protruding outwards is disposed on outer circumferential surface of the base ring, the annular upper-flange is disposed at the top of outer circumferential surface of the base ring, and an annular lower-flange radially-protruding outwards is disposed at the bottom of the outer circumferential surface of the base ring.

Preferably, an annular lower-flange radially-protruding outwards is disposed at the bottom of the outer circumferential surface of the base ring, and the annular lower-flange and the outer axial-radial lapping segment at an opening thereof are longitudinally-symmetric with the annular upper-flange and the outer axial-radial lapping segment at an opening thereof with respect to an axial middle plane of the base ring.

Preferably, a radially-traversed upper groove is disposed on upper surface to the left (including part of the flange) of the split of the base ring.

Preferably, a groove is disposed to the right of the axially-traversed outer-groove to the right of the split of the base ring (including part of the flange and on outer circumferential surface therebelow).

Preferably, a radially-traversed upper groove is disposed on upper surface to the left of the split of the base ring (including part of the flange).

Preferably, a groove is disposed to the right of the axially-traversed outer-groove to the right (including part of the flange) of the split of the base ring and on outer circumferential surface therebelow.

Preferably, an oil scraping side broadening in an axially-upward direction is disposed on outer arc-shaped surface of an axially-lapping position of the flange on the split of the base ring and to the right thereof.

Preferably, an oil scraping side broadening in an axially-downward direction is disposed on outer arc-shaped surface of an axially-lapping position of the flange on the split of the base ring and to the right thereof.

Preferably, an oil scraping side broadening in an axially-upward direction is disposed on outer arc-shaped surface of an axially-lapping position of the flange on the split of the base ring and to the left thereof.

Preferably, an oil scraping side broadening in an axially-upward direction is disposed on outer arc-shaped surface of an axially-lapping position of the flange on the split of the base ring and on both sides thereof.

Preferably, an oil scraping side broadening in an axially-downward direction is disposed on outer arc-shaped surface of an axially-lapping position of the flange on the split of the base ring and on both sides thereof.

Preferably, an upper outer-chamfer is disposed at a junction between upper surface of the flange and the outer arc-shaped surface thereof.

Preferably, the arc-shaped sealing segment and the arc-shaped upper-scraping-ring are integrally formed.

Preferably, a radially-traversed lower groove is disposed on bottom surface of both ends of the split of the base ring, and an arc-shaped upper-scraping-ring is disposed in the lower groove.

Preferably, a central angle α subtending an arc length of the axially-traversed trough is greater than a central angle β of the radially-traversed upper groove, and an arc length of the arc-shaped sealing segment is greater than that of the arc-shaped upper-scraping-ring.

Preferably, at least one radial oil leakage channel is disposed on the base ring.

Since the oil sealing ring of the invention employs the axially-traversed trough disposed on the inner circumferential surface to the left of the split of the base ring, the radially-traversed upper groove disposed on the upper surface (including part of the flange) to the left of the split of the base ring, the outer radial lapping segment and the outer axial-radial lapping segment disposed to the left of the base ring, the axially-traversed outer groove disposed on the outer circumferential surface to the right of the base ring, a groove disposed on the outer circumferential surface to the right of the axially-traversed outer-groove to the right of the split of the base ring (including part of the flange and on outer circumferential surface therebelow), the inner radial lapping segment and the inner axial-radial lapping segment disposed to the right of the base ring, the outer axial-radial lapping segment to the left of the base ring is inserted into the groove to the right of the base ring, and the outer radial lapping segment to the left of the base ring is inserted into the axially-traversed outer groove to the right of the base ring to form the axially- and radially-connected split, the leakage in an axial or radial direction at the split of the base ring is prevented.

### BRIEF DESCRIPTION OF THE DRAWINGS

FIG. 1 is a front view of an oil sealing ring according to a first embodiment of the invention;

FIG. 2 is a top view of an oil sealing ring according to a first embodiment of the invention;

FIG. 3 is a cross-sectional view along the line C-C in FIG. 1;

FIG. 4 is a cross-sectional view along the line B-B in FIG. 1;

FIG. 5 is a cross-sectional view along the line A-A in FIG. 2;

FIG. 6 is a front view of an oil sealing ring according to a second embodiment of the invention;

FIG. 7 is a top view of an oil sealing ring according to a second embodiment of the invention;

FIG. 8 is a cross-sectional view along the line A-A in FIG. 7;

FIG. 9 is a cross-sectional view along the line B-B in FIG. 7;

FIG. 10 is a top view of a base ring 2 with an opening split according to a second embodiment of the invention;

FIG. 11 is a cross-sectional view along the line B-B in FIG. 10;

FIG. 12 is a cross-sectional view along the line D-D in FIG. 10;

FIG. 13 is a front view of an oil sealing ring according to a third embodiment of the invention;

FIG. 14 is a top view of an oil sealing ring according to a third embodiment of the invention;

FIG. 15 is a cross-sectional view along the line A-A in FIG. 14;

FIG. 16 is a top view of an oil sealing ring according to a fourth embodiment of the invention;

FIG. 17 is across-sectional view along the line A-A in FIG. 16;

FIG. 18 illustrates an arc-shaped sealing segment 86 and an arc-shaped upper-scraping-ring 88 integrally formed;

FIG. 19 is a cross-sectional view along the line B-B in FIG. 18;

FIG. 20 is a front view of a base ring 2 of an oil sealing ring of FIG. 16 of a fourth embodiment of the invention;

FIG. 21 illustrates an annular flange 7 radially-protruding outwards and disposed at the bottom of the outer circumferential surface of a base ring 2 of FIG. 16;

FIG. 22 is a cross-sectional view of along the line A-A in FIG. 21;

FIG. 23 is illustrates an arc-shaped sealing segment 86, an arc-shaped upper-scraping-ring 88, and an arc-shaped lower-scraping-ring 80 integrally formed;

FIG. 24 is across-sectional view along the line B-B in FIG. 23;

FIG. 25 illustrates a spring expanding ring 9 disposed on the inner circumferential surface of a base ring 2 shown FIG. 2 according to a first embodiment of the invention;

FIG. 26 is a cross-sectional view along the line C-C in FIG. 25;

FIG. 27 is a cross-sectional view along the line A-A in FIG. 25;

FIG. 28 is a cross-sectional view along the line B-B in FIG. 25;

FIG. 29 illustrates an annular upper-flange 1′ disposed at the top of outer circumferential surface of a base ring 2, in which only one annular upper-flange 1′ radially-protrudes outwards and is disposed on the outer circumferential surface of the base ring 2;

FIG. 30 is a cross-sectional view along the line C-C in FIG. 29;

FIG. 31 is a cross-sectional view along the line A-A in FIG. 29;

FIG. 32 is a cross-sectional view along the line B-B in FIG. 29;

FIG. 33 illustrates an annular middle-flange 1″ disposed in the middle of the outer circumferential surface of a base ring 2, in which one annular middle-flange 1″ radially-protrudes outwards and is disposed on the outer circumferential surface of the base ring 2;

FIG. 34 is a top view of the base ring 2 having a spring expanding ring 9 in the inner circumferential surface thereof shown in FIG. 33;

FIG. 35 is a cross-sectional view along the line C-C in FIG. 33;

FIG. 36 is a cross-sectional view along the line A-A in FIG. 33;

FIG. 37 is a cross-sectional view along the line B-B in FIG. 33;

FIG. 38 illustrates an annular lower-flange 7 radially-protruding outwards and disposed at the bottom of the outer circumferential surface of the base ring 2 shown in FIG. 29, in which the annular lower-flange 7 and an outer axial-radial lapping segment at the opening thereof are longitudinally symmetric with an annular upper-flange 1′ and an outer axial-radial lapping segment at an opening thereof with respect to an axial middle plane 8 of the base ring 2;

FIG. 39 illustrates an oil scraping side 61 broadening in an axially-upward direction and disposed on outer arc-shaped surface of an axially-lapping position 20 of a flange on the split of the base ring 2 and to the right thereof;

FIG. 40 is a cross-sectional view along the line B-B in FIG. 39, in which an oil scraping side 61 broadens in an axially-upward direction and is disposed on the outer arc-shaped surface of an axially-lapping position 20 of the flange on the split of the base ring 2 and to the right thereof;

FIG. 41 illustrates an oil scraping side 61 broadening in an axially-upward direction and disposed on outer arc-shaped surface of an axially-lapping position 20 of the flange on the split of the base ring 2 and to the right thereof of FIG. 33;

FIG. 42 illustrates an oil scraping side 91 broadening in an axially-upward direction and disposed on outer arc-shaped surface of an axially-lapping position 20 of the flange on the split of the base ring 2 and on both sides thereof, along with an oil scraping side 92 broadening in an axially-downward direction and disposed on outer arc-shaped surface of the axially-lapping position 20 of the flange on the split of the base ring 2 and on both sides thereof of FIG. 38;

FIG. 43 illustrates an oil-leakage channel 3 radially-disposed on lower surface of the base ring of FIG. 33;

FIG. 44 is a (partial) top view of a base ring with an opening split of FIG. 2 according to a first embodiment of the invention;

FIG. 45 is a cross-sectional view along the line A-A after rotation in FIG. 44;

FIG. 46 is a cross-sectional view along the line B-B after rotation in FIG. 44;

FIG. 47 is a cross-sectional view along the line C-C after rotation in FIG. 44;

FIG. 48 is a cross-sectional view along the line D-D after rotation in FIG. 44;

FIG. 49 is a (partial) front view of a base ring 2 with an opening split of FIG. 1 according to a first embodiment of the invention;

FIG. 50 illustrates an oil scraping side 91 broadening in an axially-upward direction and disposed on outer arc-shaped surface of an axially-lapping position 20 of the flange on the split of the base ring 2 and on both sides thereof, along with an oil scraping side 92 broadening in an axially-downward direction and disposed on outer arc-shaped surface of the axially-lapping position 20 of the flange on the split of the base ring 2 and on both sides thereof of FIG. 1;

FIG. 51 is a cross-sectional view along the line B-B in FIG. 50, in which an oil scraping side 91 thickens in an axially-upward direction and is disposed on outer arc-shaped surface of an axially-lapping position 20 of the flange on the split of the base ring 2 and on both sides thereof, and an oil scraping side 92 thickens in an axially-downward direction and is disposed on outer arc-shaped surface of the axially-lapping position 20 of the flange on the split of the base ring 2 and on both sides thereof;

FIG. 52 illustrates an oil scraping side 91 broadening in an axially-upward direction and disposed on outer arc-shaped surface of an axially-lapping position 20 of the flange 1′ on the split of the base ring 2 and on both sides thereof, an oil scraping side 92 broadening in an axially-downward direction and disposed on outer arc-shaped surface of the axially-lapping position 20 of the flange 1′ on the split of the base ring 2 and on both sides thereof of FIG. 38 an oil scraping side 91 broadening in an axially-upward direction and disposed on outer arc-shaped surface of an axially-lapping position 20 of the flange 7 on the split of the base ring 2 and on both sides thereof, and an oil scraping side 92 broadening in an axially-downward direction and disposed on outer arc-shaped surface of the axially-lapping position 20 of the flange 7 on the split of the base ring 2 and on both sides thereof of FIG. 38;

FIG. 53 illustrates an upper outer-chamfer 65 disposed at a junction between upper surface of the flange 1 and outer arc-shaped surface thereof;

FIG. 54 illustrates an upper outer-chamfer 98 disposed at a junction between upper surface of the flange 1 and outer arc-shaped surface thereof;

FIG. 55 illustrates an oil scraping side 62 broadening in an axially-downward direction and disposed on outer arc-shaped surface of an axially-lapping position 20 of the flange 1 on the split of the base ring 2 and to the right thereof of FIG. 39;

FIG. 56 illustrates an oil scraping side 91 broadening in an axially-upward direction and disposed on outer arc-shaped surface of an axially-lapping position 20 of the flange 1 on the split of the base ring 2 and on both sides thereof of FIG. 1;

FIG. 57 illustrates an oil scraping side 62 broadening in an axially-downward direction and disposed on outer arc-shaped surface of an axially-lapping position 20 of the flange 1 on the split of the base ring 2 and to the right thereof of FIG. 1;

FIG. 58 illustrates an oil scraping side 91 broadening in an axially-upward direction and disposed on outer arc-shaped surface of an axially-lapping position 20 of the flange 1″ on the split of the base ring 2 and on both sides thereof of FIG. 33;

FIG. 59 illustrates an oil scraping side 92 broadening in an axially-downward direction and disposed on outer arc-shaped surface of the axially-lapping position 20 of the flange 1″ on the split of the base ring 2 and on both sides thereof of FIG. 33;

FIG. 60 is a top view of a base ring 2 having a spring expanding ring 9 in inner circumferential surface thereof of FIG. 7 according to a second embodiment of the invention;

FIG. 61 is a cross-sectional view along the line A-A in FIG. 60;

FIG. 62 is a cross-sectional view along the line B-B in FIG. 60; and

FIG. 63 illustrates an oil scraping side 99 broadening in an axially-upward direction and disposed on outer arc-shaped surface of an axially-lapping position 20 of the flange on the split of the base ring 2 and to the left thereof of FIG. 13.

### DETAILED DESCRIPTION OF THE INVENTION

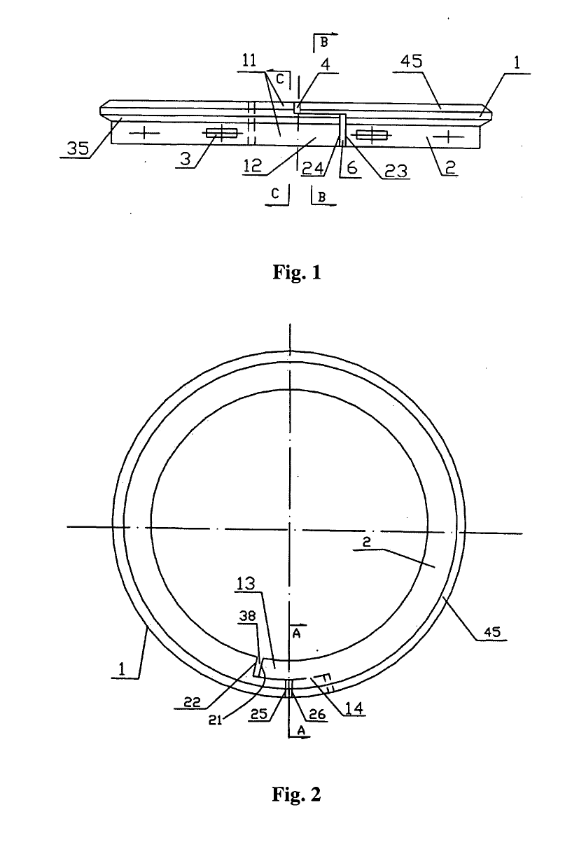

FIGS. 1-5 illustrate an oil sealing ring of a first embodiment of the invention.

FIG. 1 shows a front view of a base ring 2 of an oil sealing ring according to a first embodiment of the invention. FIG. 2 shows a top view of an oil sealing ring according to a first embodiment of the invention. As shown in FIG. 2, the oil sealing ring of the invention comprises a base ring 2 having a split, and an annular flange 1 radially-protruding outwards is disposed on an outer circumferential surface of the base ring 2. A central axis of the outer circumferential surface of the flange 1 coincides with that of the outer circumferential surface of the base ring 2. A chamfer 45 is disposed at a junction between upper surface of the annular flange 1 and the outer circumferential surface thereof, and a lower outer-chamber 35 is disposed at a junction between lower surface of the annular flange 1 and the outer circumferential surface thereof. This reduces axial height of the annular flange 1 and the area of the outer circumferential surface, and therefore also reduces the contact area and friction with respect to a cylinder wall, as shown in FIG. 1.

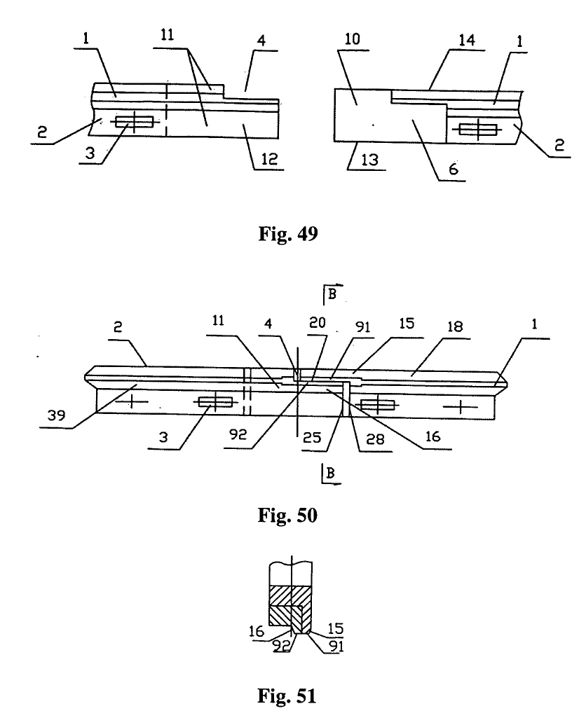

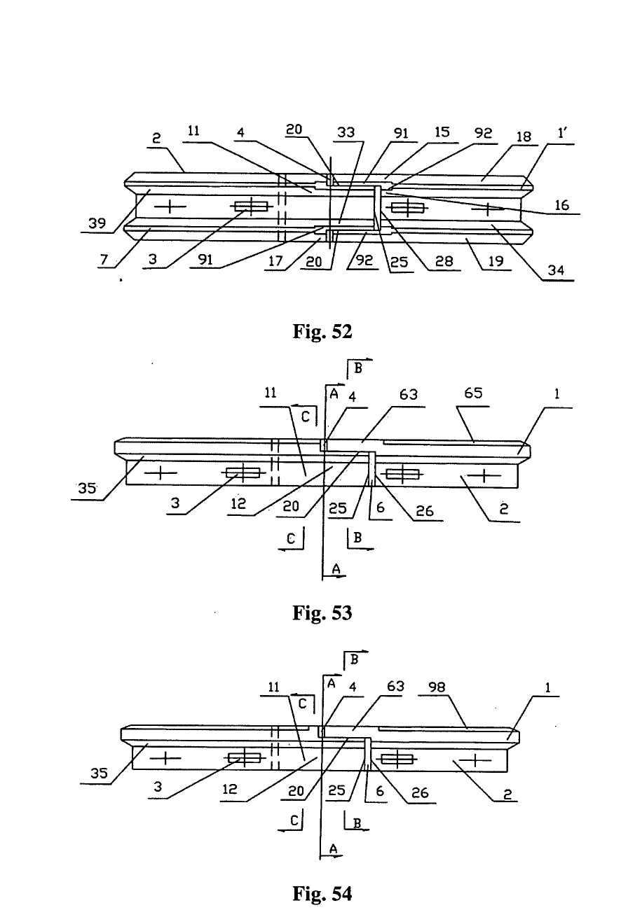

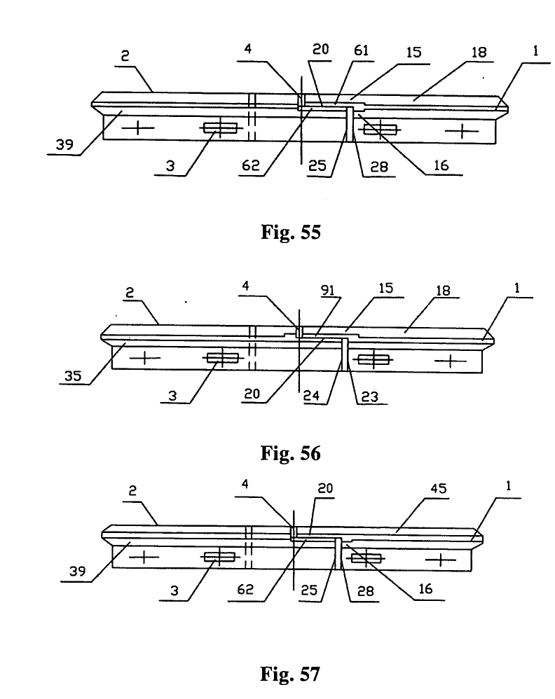

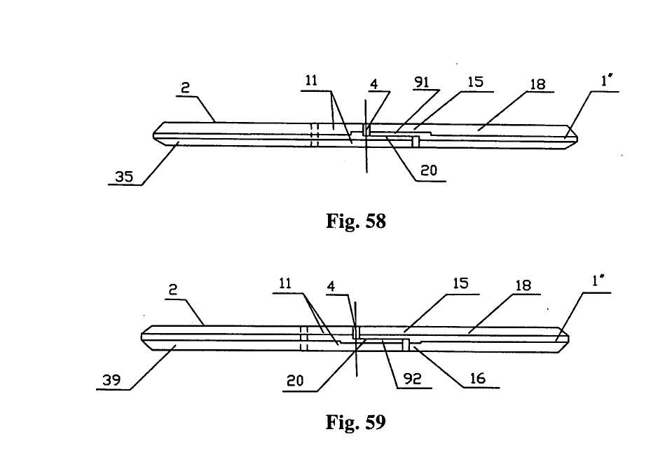

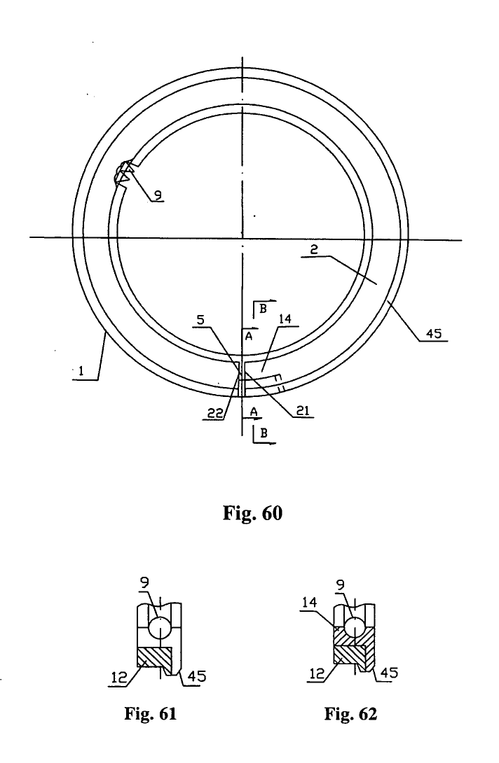

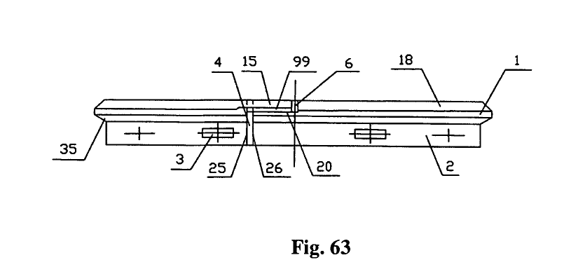

The base ring 2 is a circular ring having a split, which is well-known in the art, and will not be described hereinafter. An axially-traversed trough 38 is disposed on the inner circumferential surface to the left of the split of the base ring 2, as shown in FIG. 44. A radially-traversed upper groove 4 is disposed on the upper surface (including a part of the flange) to the left of the split of the base ring 2. The lower bottom surface of the upper groove 4 is disposed in a position that is at the half axial height of the outer circumferential surface of the flange 1, as shown in FIG. 1. An outer radial lapping segment 11 and an outer axial-radial lapping segment 12 are formed to the left of the base ring 2, as shown in FIG. 49. An axially-traversed outer groove 10 is disposed on the outer circumferential surface to the right of the base ring 2 and a groove 6 is disposed on the outer circumferential surface to the right of the axially-traversed outer-groove 10 to the right of the split of the base ring 2 (including a part of the flange and parts therebelow). The axial height of the groove 6 is disposed at a position that is at the half height of the outer circumferential surface of the flange 1, as shown in FIG. 1.

An inner radial lapping segment 13 and an inner axial-radial lapping segment 14 are formed to the right of the base ring 2, as shown in FIG. 44. The outer axial-radial lapping segment 12 to the left of the base ring 2 is inserted into a groove 6 to the right of the base ring 2, and the outer radial lapping segment 11 to the left of the base ring 2 is inserted into an axially-traversed outer-groove 10 to the right of the base ring 2, so as to form radial joint between the inner radial lapping segment 13 and the outer radial lapping segment 11. The inner axial-radial lapping segment 14 is radially- and axially-connected with the outer axial-radial lapping segment 12. The bottom surface of the axially-traversed trough 38 is arc-shaped, as shown in FIG. 44. A center of a radius of the arc-shaped surface coincides with that of the outer circumferential surface of the base ring 2. The bottom surface of the groove 6 and the axially-traversed outer-groove 10 are arc-shaped surfaces, as shown in FIG. 44. The radius of the arc-shaped surface is the same as that of the bottom surface of the axially-traversed trough 38, and both centers thereof coincide with each other.

The bottom surface 49 (as shown in FIG. 48, which is a cross-sectional view of FIG. 44 along the line D-D) of the groove 6 and bottom surface 47 (as shown in FIG. 47, which is a cross-sectional view of FIG. 44 along the line C-C) of the axially-traversed outer-groove 10 are arc-shaped. To prevent deadlock of both ends of the split of the base ring 2, a gap is disposed between a right end 21 of the split of the base ring 2 and a side 22 of the axially-traversed trough 38 connected thereto, a gap is disposed between a left end 24 of the outer axial-radial lapping segment 12 and a right side 23 of the groove 6 connected thereto, and a gap is disposed between a side 25 of the radially-traversed upper groove 4 and a side 26 of the axially-traversed outer-groove 10 connected thereto.

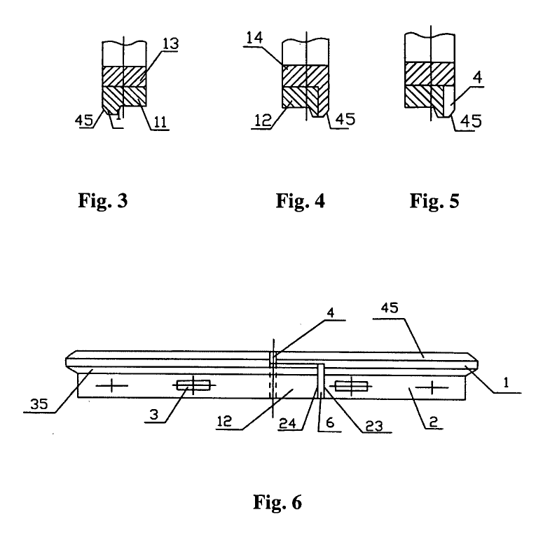

The bottom surface 36 of the radially-traversed upper groove 4 disposed at the top of the outer axial-radial lapping segment 12 (as shown in FIG. 46) is contacted with an upper side 38 (as shown in FIG. 48) of the groove 6 connected thereto (but assembly clearance is reserved). The inner arc-shaped surface 46 of the outer radial lapping segment 11 (as shown in FIG. 45, which is a cross-sectional view of FIG. 44 along the line A-A) is contacted with an outer arc-shaped surface 47 (as shown in FIG. 47) of the inner radial lapping segment 13. The inner arc-shaped surface 48 of the outer axial-radial lapping segment 12 (as shown in FIG. 46, which is a cross-sectional view of FIG. 44 along the line B-B) is contacted with the bottom surface 49 of the groove 6 disposed on the outer arc-shaped surface of the inner axial-radial lapping segment 14 (as shown in FIG. 48, which is a cross-sectional view of FIG. 44 along the line D-D). FIG. 3 is a cross-sectional view of FIG. 1 along the line C-C, FIG. 4 is a cross-sectional view of FIG. 1 along the line B-B, and FIG. 5 is a cross-sectional view of FIG. 2 along the line A-A.

FIGS. 6-12 illustrate an oil sealing ring of a second embodiment of the invention.

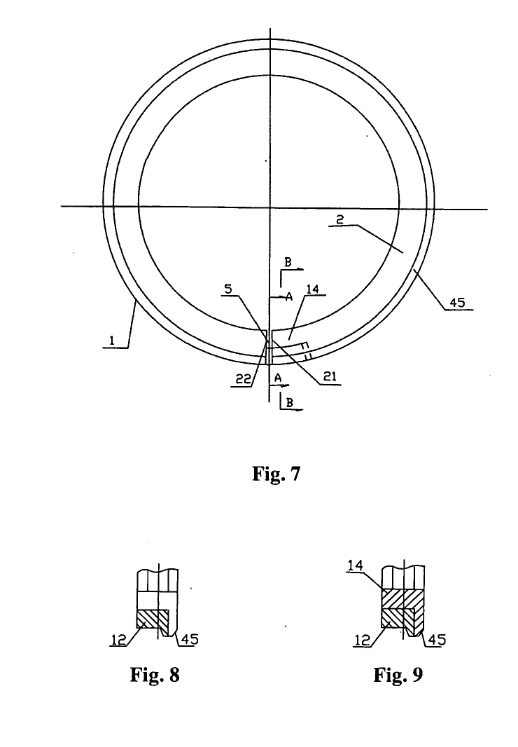

FIG. 6 is a front view of the base ring 2 of an oil sealing ring according to a second embodiment of the invention. FIG. 7 is a top view of an oil sealing ring according to a second embodiment of the invention. As shown in FIG. 7, an axially-traversed trough 5 is disposed on inner circumferential surface to the left of the split of the base ring 2. A radially-traversed upper groove 4 is disposed on the upper surface to the left of the split of the base ring 2. A lower bottom surface of the radially-traversed upper groove 4 is disposed in a position that is at half axial height of the outer circumferential surface of the flange 1, as shown in FIG. 6. An outer axial-radial lapping segment 12 is formed to the left of the base ring 2. A groove 6 is disposed to the right of the split of the base ring 2 including part of the flange and on outer circumferential surface therebelow. An axial height of the groove 6 is disposed in a position that is at half axial height of the outer circumferential surface of the flange 1, as shown in FIG. 6.

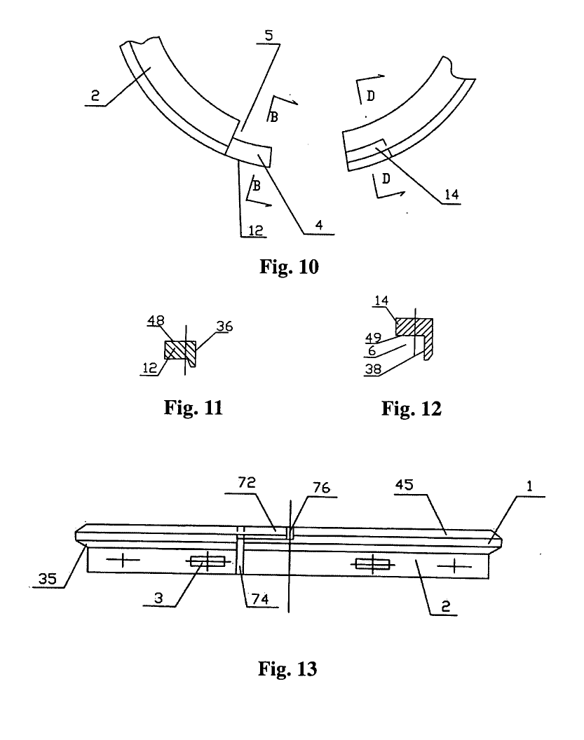

An inner axial-radial lapping segment 14 is formed to the right of the base ring 2. The outer axial-radial lapping segment 12 to the left of the base ring 2 is inserted into a groove 6 to the right of the base ring 2, so as to form an axially- and radially-connected split. The bottom surface of the axially-traversed trough 5 is arc-shaped, as shown in FIG. 10. A center of a radius of the arc-shaped surface coincides with that of the outer circumferential surface of the base ring 2. The bottom surface of the groove 6 is an arc-shaped surface, as shown in FIGS. 10 and 12. A radius of the arc-shaped surface is the same as that of the bottom surface of the axially-traversed trough 5, and both centers thereof coincide with each other. The arc-shaped surface of the bottom surface 49 of the groove 6 is contacted with arc-shaped surface of the bottom surface 48 of the axially-traversed trough 5 (assembly clearance is reserved). To prevent deadlock of both ends of the split of the base ring 2, a gap is disposed between a right end 21 of the split of the base ring 2 and a side 22 of the axially-traversed trough 5 connected thereto, a gap is disposed between a left end 24 of the outer axial-radial lapping segment 12 on a left of the split of the base ring 2 and a side 23 of the groove 6 connected thereto, as shown in FIG. 6. The bottom surface 36 of the radially-traversed upper groove 4 is contacted with an upper side 38 of the groove 6 connected thereto (but assembly clearance is reserved).

FIG. 8 is a cross-sectional view of FIG. 7 along the line A-A. FIG. 9 is a cross-sectional view of FIG. 7 along the line B-B. FIG. 10 is a top view of a base ring 2 with an opening split of a second embodiment of the invention. FIG. 11 is a cross-sectional view of FIG. 10 along the line B-B. FIG. 12 is a cross-sectional view of FIG. 10 along the line D-D.

FIGS. 13-15 illustrate an oil sealing ring according to a third embodiment of the invention.

FIG. 13 is a front view of an oil sealing ring of a third embodiment of the invention. FIG. 14 is a top view of an oil sealing ring of a third embodiment of the invention. As shown in FIG. 14, an axially-traversed trough 5 is disposed on inner circumferential surface to the left of the split of the base ring 2, an radially-traversed lower groove 74 is disposed on left lower surface (including part of the flange and parts therebelow) of the split of the base ring 2, a lapping segment 72 is formed to the left of the base ring 2, an upper groove 76 is disposed on the top (including part of the flange) of the outer circumferential surface to the right of the split of the base ring 2. The lower groove 74 is disposed in a position that is at half axial height of the outer circumferential surface of the flange 1, as shown in FIG. 13. A lower bottom surface of the upper groove 76 is disposed in a position that is at half height of the outer circumferential surface of the flange 1, as shown in FIG. 13.

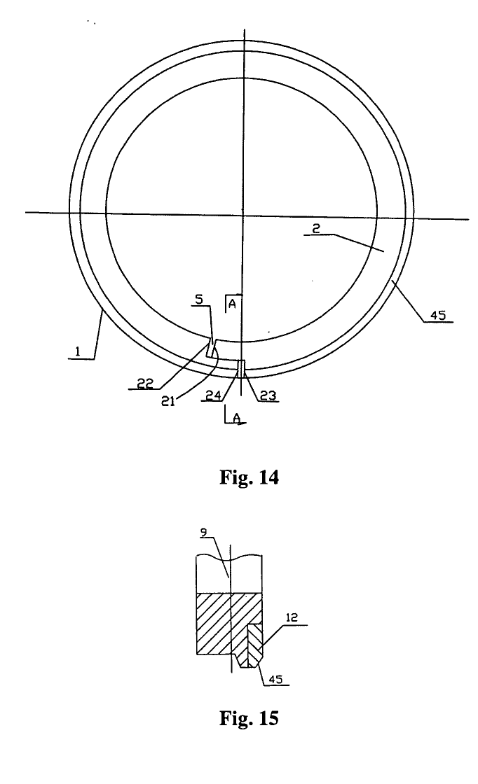

The lapping segment 72 to the left of the base ring 2 is inserted into the upper groove 76 to the right of the base ring 2, so as to form an axially- and radially-connected split. Bottom surface of the axially-traversed trough 5 is arc-shaped surface. A center of a radius of the arc-shaped surface coincides with that of the outer circumferential surface of the base ring 2. The bottom surface of the upper groove 76 is an arc-shaped surface, and a radius of the arc-shaped surface is the same as that of the bottom surface of the axially-traversed trough 5, and both centers thereof coincide with each other. The arc-shaped surface of the bottom surface of the upper groove 76 is contacted with the arc-shaped surface of the bottom surface of the axially-traversed trough 5 (assembly clearance is reserved). To prevent deadlock of both ends of the split of the base ring 2, a gap is disposed between a right end 21 of the split of the base ring 2 and a side 22 of the axially-traversed trough 5 connected thereto, a gap is disposed between a left end 24 of the lapping segment 72 and a side 23 of the upper groove 76 connected thereto, and bottom surface of the lapping segment 72 is contacted with a lower side of the upper groove 76 connected thereto (but assembly clearance is reserved). FIG. 15 is a cross-sectional view of FIG. 14 along the line A-A.

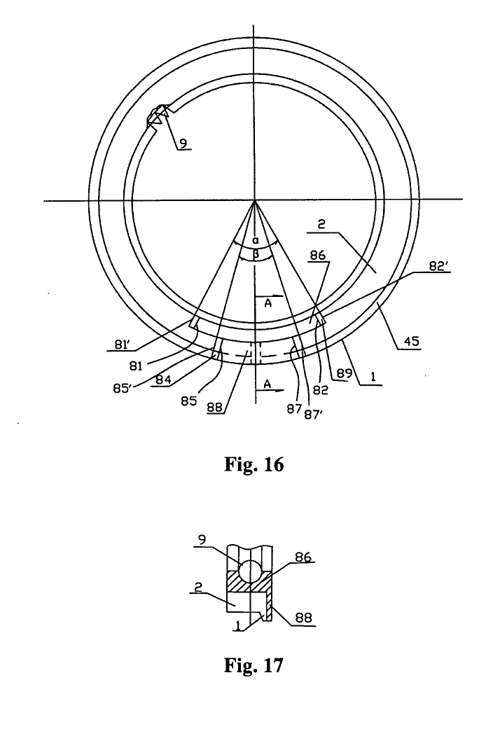

FIGS. 16-20 illustrate an oil sealing ring according to a fourth embodiment of the invention.

FIG. 16 is a top view of an oil sealing ring of a fourth embodiment of the invention. As shown in FIG. 16, a radially-traversed upper trough 84 is disposed on the upper surface (comprising a chamfer 45) of both ends of a split 83 of a base ring 2. As shown in FIG. 20, an axially-traversed groove 89 is disposed on the inner circumferential surface of both ends of the split 83 of the base ring 2, and an arc-shaped sealing segment 86 is disposed in the axially-traversed groove 89. The bottom surface of the axially-traversed trough 89 is an arc-shaped surface, and a center of a radius of the arc-shaped surface coincides with that of the outer circumferential surface of the base ring 2. A radius of outer circumferential surface of the arc-shaped sealing segment 86 is the same as that of the bottom surface of the axially-traversed trough 89, and both centers thereof coincide with each other.

A radius of inner circumferential surface of the arc-shaped sealing segment 86 is the same as that of inner circumferential surface of the base ring 2, and both centers thereof coincide with each other. The upper surface of the arc-shaped sealing segment 86 is on a same plane as that of the base ring 2, while lower surface of the arc-shaped sealing segment 86 is on a same plane as that of the base ring 2. The outer circumferential surface of the arc-shaped sealing segment 86 is contacted with the bottom surface of the axially-traversed trough 89. To prevent deadlocking between both ends 81 and 82 of the arc-shaped sealing segment 86 and those 81′ and 82′ of the axially-traversed trough 89, a gap should be disposed therebetween. An arc-shaped upper-scraping-ring 88 is disposed in the radially-traversed upper trough 84. The bottom surface of the arc-shaped upper-scraping-ring 88 is contacted with bottom surface of the radially-traversed upper trough 84 (but an assembly gap is reserved), and upper surface thereof is on a same plane as that of the base ring 2. A radius of inner arc-shaped surface of the arc-shaped upper-scraping-ring 88 is the same as that of outer arc-shaped surface of the arc-shaped sealing segment 86, and both centers thereof coincide with each other. The inner arc-shaped surface of the arc-shaped upper-scraping-ring 88 is connected with the outer arc-shaped surface at the top of the arc-shaped sealing segment 86, a radius of outer arc-shaped surface of the arc-shaped upper-scraping-ring 88 is the same as that of outer circumferential surface of the annular flange 1 radially-protruding outwards, and both centers thereof coincide with each other.

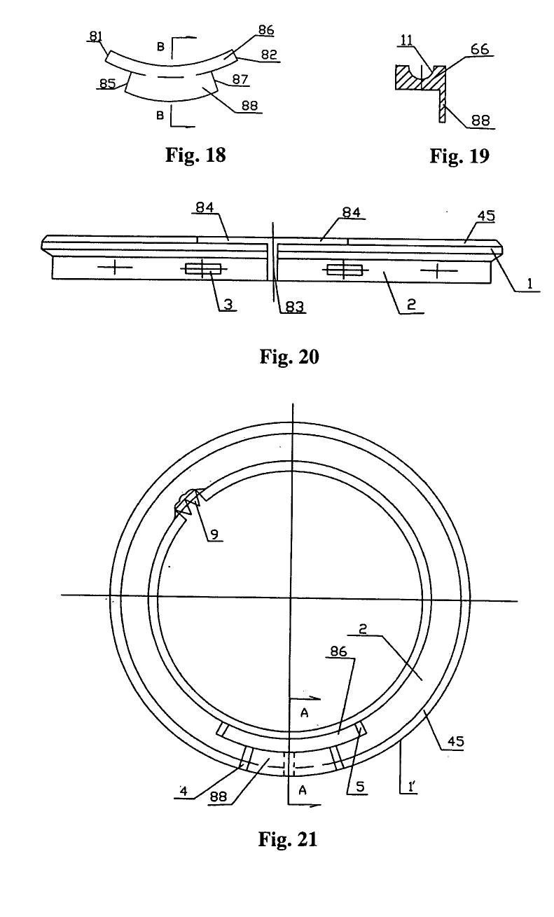

FIG. 17 is a cross-sectional view of FIG. 16 along the line A-A. As shown in FIG. 18, according to a preferred embodiment, the arc-shaped sealing segment 86 and the arc-shaped upper-scraping-ring 88 is integrally formed. FIG. 19 is a cross-sectional view of a FIG. 18 along the line B-B. To prevent deadlocking between both ends 85 and 87 of the arc-shaped upper-scraping-ring 88 and those 85′ and 87′ of the radially-traversed upper trough 84, a gap should be disposed therebetween. A spring expanding ring 9 is disposed on the inner circumferential surface in the base ring 2 and the arc-shaped sealing segment 86, according to a preferred embodiment, a plurality of spring grooves 11 are disposed on inner circumferential surface in the base ring 2 and the arc-shaped sealing segment 86, and the spring expanding ring 9 is received in the spring groove 11.

The central angle α subtending an arc length of the axially-traversed groove 89 is greater than the central angle β of the radially-traversed upper trough 84, and the arc length of the arc-shaped sealing segment 86 is greater than that of the arc-shaped upper-scraping-ring 88, as shown in FIG. 16. At least one or a plurality of oil leakage channel(s) 3 is/are radially-disposed in the base ring 2, as shown in FIG. 20. The oil leakage channel 3 is radially-disposed in the middle or at the bottom of the base ring 2, namely, is not intersected with the annular flange of the base ring 2. FIG. 20 is a front view of a base ring 2 of an oil sealing ring of a fourth embodiment of the invention.

The spring expanding ring 9 is coil-spring loaded or snake-shaped. A coil-spring loaded structure is formed by connecting two ends of a curved coiled spring, and a latch pin is disposed in an inner circular hole between both ends thereof. Preferably, a coil loaded spring is used.

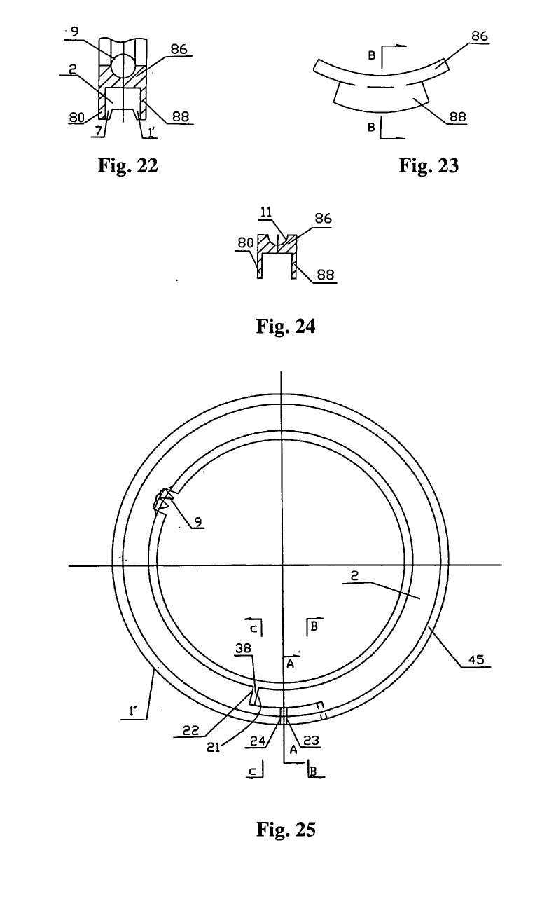

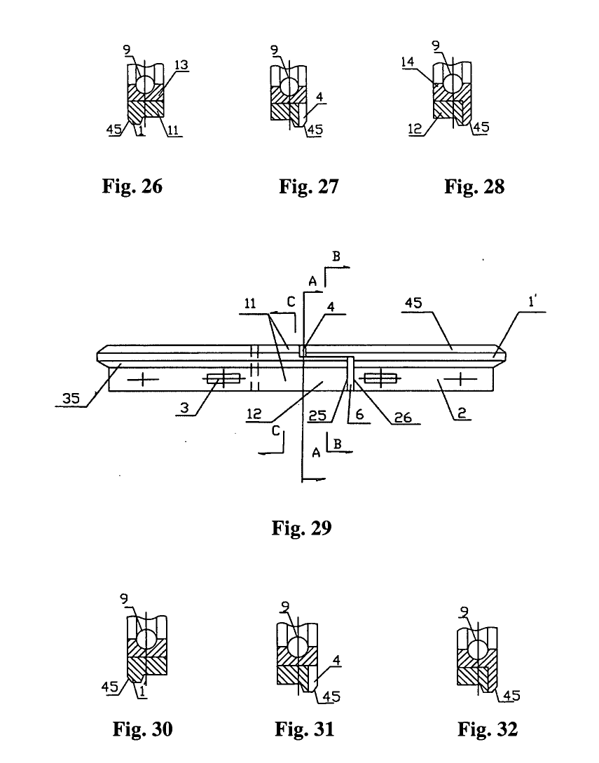

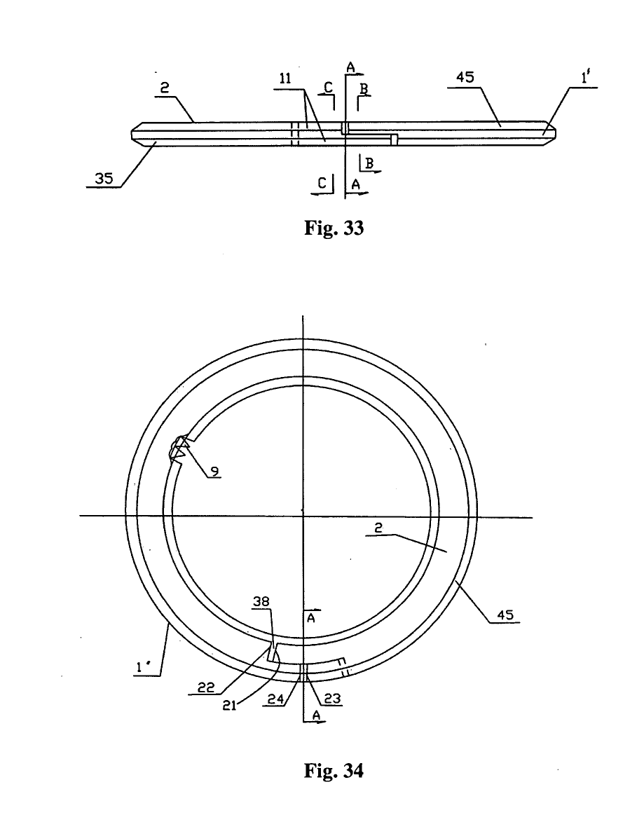

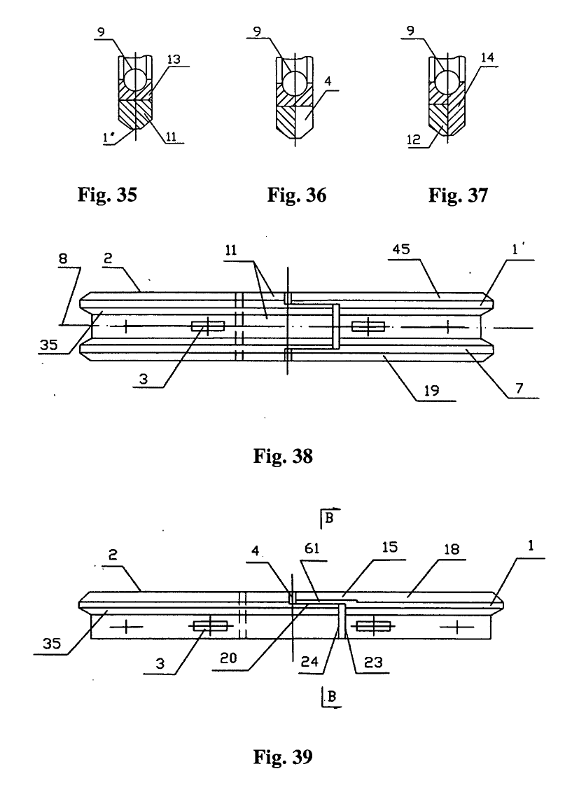

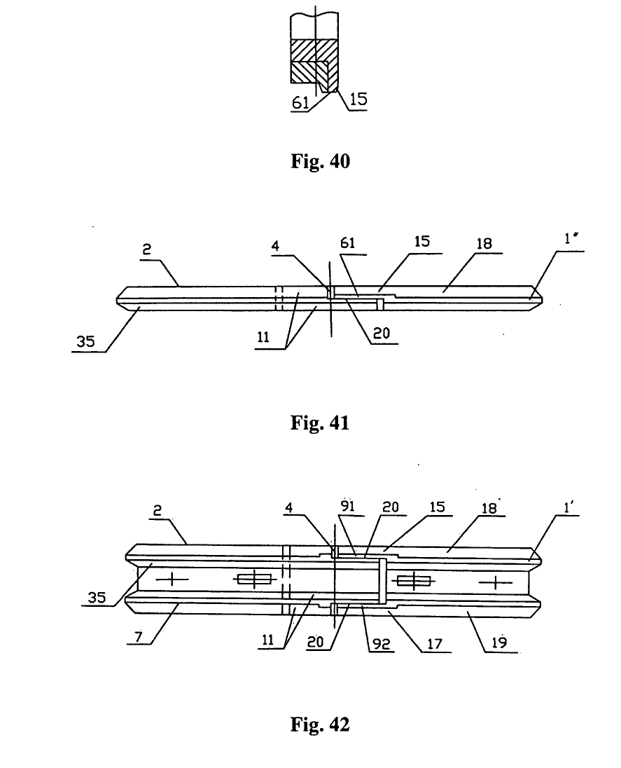

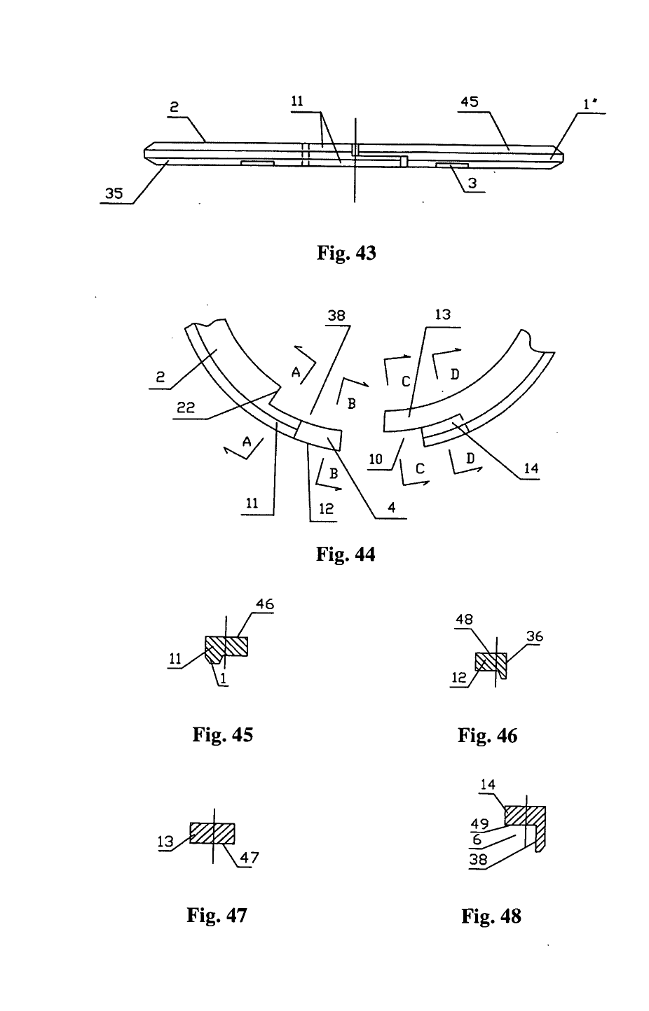

FIG. 21 illustrates an annular upper flange 1′ radially-protruding outwards and disposed at the top of outer circumferential surface of the base ring 2 and an annular lower flange 7 radially-protruding outwards and disposed at the bottom of the outer circumferential surface of the base ring 2 of FIG. 16. FIG. 22 is a cross-sectional view along the line A-A of FIG. 21. A radius of outer circumferential surface of the annular lower flange 7 is the same as that of the annular upper flange 1′, and both centers thereof coincide with each other. The annular lower flange 7 and the base ring 2 are integrally formed. An upper chamfer is disposed at a junction between bottom surface of the base ring 2 and the outer circumferential surface of the annular lower flange 7, which makes it easy to dispose a radially-traversed lower groove on bottom surface of both ends of the split 83 of the base ring 2 and an arc-shaped lower-scraping-ring 80, and reduces the axial height and the area of the outer circumferential surface of the annular lower flange 7, and therefore reduces the area and friction with respect to a cylinder wall.

A radially-traversed lower groove is disposed on bottom surface of both ends of the split 83 of the base ring 2. The radially-traversed lower groove and the radially-traversed upper trough 84 are symmetrically distributed with respect to a central horizontal plane of axial height of the base ring 2. The arc-shaped lower-scraping-ring 80 is disposed in the radially-traversed lower groove. Upper surface of the arc-shaped lower-scraping-ring 80 is contacted with the bottom surface of the radially-traversed lower groove (but an assembly gap is reserved), and lower surface thereof is on the same plane as that of the base ring 2. A radius of inner arc-shaped surface of the arc-shaped lower-scraping-ring 80 is the same as that of the outer arc-shaped surface of the arc-shaped sealing segment 86, and both centers thereof coincide with each other. The inner arc-shaped surface of the arc-shaped lower-scraping-ring 80 is contacted with the outer arc-shaped surface at the bottom of the arc-shaped sealing segment 86. A radius of the outer circumferential surface of the arc-shaped lower-scraping-ring 80 is the same as that of the outer circumferential surface of the annular lower flange 7, and both centers thereof coincide with each other. To prevent deadlocking between both ends of the arc-shaped lower-scraping-ring 80 and those of the radially-traversed lower groove, a gap must be disposed therebetween.

According to a preferred embodiment, the arc-shaped sealing segment 86, the arc-shaped upper-scraping-ring 88 and the arc-shaped lower-scraping-ring 80 are integrally formed, as shown in FIG. 23. FIG. 24 is a cross-sectional view along the line B-B in FIG. 23.

As shown in FIG. 50, an oil scraping side 91 broadening in an axially-upward direction is disposed on outer arc-shaped surface of an axially-lapping position 20 of the flange on the split of the base ring 2 and on both sides thereof. FIG. 51 is a cross-sectional view along the line B-B of FIG. 50. A groove 6 is disposed to the right of the axially-traversed outer-groove 10 to the right of the split of the base ring 2 (including part of the flange and on outer circumferential surface therebelow). The groove 6 is disposed in a position that is at half axial height of the outer circumferential surface of the flange 1, as shown in FIG. 1.

The flange at the axially-lapping position is very thin and low intensity, poor sealing performance and small chromium plating joint surface. To enhance intensity of the flange at the axially-lapping position, enlarge chromium plating joint surface and improve sealing performance, an oil scraping side 91 broadening in an axially-upward direction is disposed on outer arc-shaped surface of the axially-lapping position 20 of the flange and on both sides thereof; and an oil scraping side 92 broadening in an axially-downward direction is disposed on outer arc-shaped surface of the axially-lapping position 20 of the flange on the split of the base ring 2 and on both sides thereof, as shown in FIG. 51. This is because the radially-traversed upper groove 4 is disposed on upper surface (including part of the flange) to the left of the split of the base ring 2. A lower bottom surface of the upper groove 4 is disposed in a position that is at half axial height of the outer circumferential surface of the flange 1, as shown in FIG. 1.

The flange at the connected position is very thin and low intensity, poor sealing performance and small chromium plating joint surface. To enhance intensity of the flange at the connected position, enlarge chromium plating joint surface and improve sealing performance, an oil scraping side 92 broadening in an axially-downward direction is disposed on outer arc-shaped surface of the axially-lapping position 20 of the flange and on both sides thereof. This design guarantees intensity of an oil scraping side at the split of the base ring 2, prevents dechroming (a layer of chromium needs to be electroplated on the surface of a piston ring), and offers good sealing performance at the split of the base ring 2.

An upper chamfer 15 is disposed at a junction between the upper surface of the oil scraping side 91 broadening in an axially-upward direction and the outer arc-shaped surface of thereof. A large upper chamfer 18 is disposed at a junction between upper surface of the flange 1 and outer arc-shaped surface thereof. A lower chamfer 16 is disposed at a junction between the lower surface of the oil scraping side 92 broadening in an axially-downward direction and the outer arc-shaped surface thereof. A large lower chamfer 39 is disposed at a junction between the lower surface of the flange 1 and the outer arc-shaped surface thereof, which greatly reduces the axial height of the flange 1 (oil scraping side) and therefore reduces the friction.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. An oil sealing ring, comprising
a base ring (2) having a split; and
an annular flange (1) radially-protruding outwards and disposed on an outer circumferential surface of said base ring (2);
wherein
an axially-traversed trough (38) is disposed on an inner circumferential surface to the left of said split and a radially-traversed upper groove (4) is disposed on upper surface to the left of the split of said base ring (2), so that an outer radial lapping segment (11) and an outer axial-radial lapping segment (12) are formed to the left of said base ring (2);
an axially-traversed outer-groove (10) disposed on said outer circumferential surface to the right of said base ring (2);
a groove (6) disposed on said outer circumferential surface and a part of the flange and parts therebelow, to the right of said axially-traversed outer groove (10);
said outer axial-radial lapping segment (12) is inserted into said groove (6); and
said outer radial lapping segment (11) is inserted into said axially-traversed outer groove (10).

2. An oil sealing ring, comprising
a base ring (2) having a split; and
an annular flange (1) radially-protruding outwards and disposed on an outer circumferential surface of said base ring (2);
wherein
an axially-traversed trough (5) is disposed on an inner circumferential surface to the left of said split, and a radially-traversed upper groove (4) is disposed on an upper surface to the left of said split, so that an outer axial-radial lapping segment (12) is formed to the left of said base ring (2);
a groove (6) being disposed on an outer circumferential surface to the right of said split; and
said outer axial-radial lapping segment (12) is inserted into said groove (6).

3. An oil sealing ring, comprising
a base ring (2) having a split; and
an annular flange (1) radially-protruding outwards and disposed on an outer circumferential surface of said base ring (2);
wherein
an axially-traversed trough (5) is disposed on an inner circumferential surface to the left of the split, and a radially-traversed lower groove (74) is disposed on the lower surface, including a part of the flange, to the left of the split of said base ring (2), so that a lapping segment (72) is formed to the left of said base ring (2);
an upper groove (76) is disposed at the top, including a part of the flange, of said outer circumferential surface to the right of the split; and
said lapping segment (72) is inserted into said upper groove (76).

4. The oil sealing ring of claim 1, wherein a spring expanding ring (9) is disposed on said inner circumferential surface of said base ring (2).

5. An oil sealing ring, comprising
a base ring (2) having a split (83); and
an annular flange (1) radially-protruding outwards and disposed on an outer circumferential surface of said base ring (2);
wherein
a radially-traversed upper trough (84) is disposed on an upper surface of both ends of said split (83) of said base ring (2);
an axially-traversed groove (89) is disposed on an inner circumferential surface of both ends of said split (83) of said base ring (2);
an arc-shaped sealing segment (86) is disposed in said axially-traversed groove (89);
an arc-shaped upper-scraping-ring (88) is disposed in said radially-traversed upper trough (84); and
a spring expanding ring (9) is disposed on said inner circumferential surface of said base ring (2) and said arc-shaped sealing segment (86).

6. The oil sealing ring of claim 1, wherein
only one annular upper-flange (1′) radially-protruding outwards is disposed on said outer circumferential surface of said base ring (2); and
said annular upper-flange (1′) is disposed at the top of said outer circumferential surface of said base ring (2).

7. The oil sealing ring of claim 1, wherein
only one annular middle-flange (1″) radially-protruding outwards is disposed on said outer circumferential surface of said base ring (2); and
said annular middle-flange (1″) is disposed in the middle of said outer circumferential surface of said base ring (2).

8. The oil sealing ring of claim 5, wherein
only one annular upper-flange (1′) radially-protruding outwards is disposed on said outer circumferential surface of said base ring (2);
said annular upper-flange (1′) is disposed at the top of said outer circumferential surface of said base ring (2); and
an annular lower-flange (7) radially-protruding outwards is disposed at the bottom of said outer circumferential surface of said base ring (2).

9. The oil sealing ring of claim 6, wherein
an annular lower-flange (7) radially-protruding outwards is disposed at the bottom of said outer circumferential surface of said base ring (2); and
said annular lower-flange (7) and said outer axial-radial lapping segment at the split thereof are longitudinally symmetric with said annular upper-flange (1′) and said outer axial-radial lapping segment at a split thereof with respect to an axial middle plane (8) of said base ring (2).

10. The oil sealing ring of claim 1, wherein a radially-traversed upper groove (4) is disposed on upper surface, including a part of said flange, to the left of said split of said base ring (2).

11. The oil sealing ring of claim 1, wherein a groove (6) is disposed to the right, including a part of said flange and on outer circumferential surface therebelow, of said axially-traversed outer-groove (10) to the right of said split of the base ring (2).

12. The oil sealing ring of claim 1, wherein an oil scraping side (61) broadening in an axially-upward direction is disposed on an outer arc-shaped surface, and in its right adjacency, of an axially-lapping position (20) of said flange on said split of said base ring (2).

13. The oil sealing ring of claim 1, wherein an oil scraping side (62) broadening in an axially-downward direction is disposed on an outer arc-shaped surface, and in its right adjacency, of an axially-lapping position (20) of said flange on said split of said base ring (2).

14. The oil sealing ring of claim 1, wherein an oil scraping side (99) broadening in an axially-upward direction is disposed on outer arc-shaped surface, and in its left adjacency, of an axially-lapping position (20) of said flange on the split of said base ring (2).

15. The oil sealing ring of claim 1, wherein an oil scraping side (91) broadening in an axially-upward direction is disposed on outer arc-shaped surface, and in its left and right adjacency, of an axially-lapping position (20) of said flange on said split of said base ring (2).

16. The oil sealing ring of claim 1, wherein an oil scraping side (92) broadening in an axially-downward direction is disposed on an outer arc-shaped surface, and in its left and right adjacency, of an axially-lapping position (20) of said flange on said split of said base ring (2).

17. The oil sealing ring of claim 1, wherein an small upper outer-chamfer (65) is disposed at a junction between upper surface of said flange (1) and said outer arc-shaped surface thereof, in addition to the outer arc-shaped surface and its right adjacency of the axially-lapping position (20) of said flange on said split of said base ring (2).

18. The oil sealing ring of claim 5, wherein said arc-shaped sealing segment (86) and said arc-shaped upper-scraping-ring (88) are integrally formed.

19. The oil sealing ring of claim 8, wherein a radially-traversed lower groove is disposed on a bottom surface of both ends of said split (83) of said base ring (2), and an arc-shaped lower-scraping-ring (80) is disposed in said lower groove.

20. The oil sealing ring of claim 5, wherein
a central angle a subtending an arc-shaped length of said axially-traversed trough (5) is greater than a central angle β said radially-traversed upper groove (4), and
an arc-shaped length of said arc-shaped sealing segment (86) is greater than that of said arc-shaped upper-scraping-ring (88).
